(19) United States
(12) Patent Application Publication
(10) Pub. No.: US 2013/0134041 A1
(43) Pub. Date: May 30, 2013

(54) DROPLET MOVING DEVICE, DROPLET MOVING METHOD, PLASMA SEPARATION DEVICE, AND PLASMA SEPARATION METHOD

(71) Applicant: TOKYO ELECTRON LIMITED, Tokyo (JP)

(72) Inventor: Akitake Tamura, Nirasaki City (JP)

(73) Assignee: TOKYO ELECTRON LIMITED, Tokyo (JP)

(21) Appl. No.: 13/745,960

(22) Filed: Jan. 21, 2013

Related U.S. Application Data
(63) Continuation of application No. PCT/JP2011/003852, filed on Jul. 6, 2011.

(30) Foreign Application Priority Data
Jul. 22, 2010 (JP) 2010-165106
Nov. 5, 2011 (JP) 2010-248972

(51) Int. Cl. G01N 1/40; F17D 1/20

(52) U.S. Cl. CPC G01N 1/4077; F17D 1/20
USPC 204/547; 137/803; 204/643

(57) ABSTRACT

A droplet can be moved along a surface of a moving surface forming member in a simple method. At both sides of the moving surface forming member 1 configured to form a moving surface on which the droplet is moved and made of a nonmagnetic material, magnetic field forming members 4A and 4B configured to form a magnetic field gradient such that intensity of a magnetic field decreases as a distance from an area where the droplet is positioned on the surface of the moving surface forming member 1 increases along the surface is provided. By relatively moving the moving surface forming member 1 with respect to the magnetic field forming members 4A and 4B along the surface, the droplet is moved along the magnetic field gradient.

### CROSS-REFERENCE TO RELATED APPLICATION

This application is a Continuation of International Application No. PCT/JP2011/003852 filed Jul. 6, 2011, which claims the benefits of Japanese Patent Application Nos. 2010-165106 and 2010-248972 filed on Jul. 22, 2010 and Nov. 5, 2010, respectively. The entire disclosure of the prior application is incorporated herein by reference in its entirety.

### FIELD OF THE INVENTION

The present disclosure relates to a technique of moving a droplet along a surface of a moving surface forming member by relatively moving a magnetic field forming member with respect to the moving surface forming member. Further, the present disclosure relates to another technique of separating plasma from blood on a surface of a moving surface forming member.

### BACKGROUND OF THE INVENTION

There is a technique called “microTAS (Micro Total Analysis Systems)” in which a series of operations for biochemical analysis are performed on a single substrate. This technique relates to a chemical analysis system in which a reaction portion or a mixing portion is formed on a substrate and blood or the like is analyzed on the substrate. In this technique, a method using a micro flow path and a method of manipulating a droplet on the substrate have been known. The method of manipulating the droplet on the substrate is called “droplet-based microTAS” and is remarkable in that a reagent is very small at several nl.

As for the technique of moving the droplet, there has been considered a method of generating, cutting, binding, and moving the droplet in a digital microfluidic circuit to which EWOD (electro wetting on dielectric) is applied. However, in this method of electrically moving the droplet, it is necessary to form a micro circuit, so that a configuration may be complicated. As a result, manufacturing cost and running cost are increased. In Patent Document 1, there is suggested a technique of diffusing a coating agent by applying a magnetic field generated from a superconductive magnet to the coating agent. However, the superconductive magnet is expensive, and, thus, it is disadvantageous in cost.

Meanwhile, as a method for detecting a specific protein by using an antigen-antibody reaction, an ELISA (Enzyme Linked Immunosorbent Assay) method has been known. In this method, after the antigen-antibody reaction between a primary antibody and a specific protein of a target object, a secondary antibody having an enzyme that specifically reacts with the primary antibody reacts therewith. Then, after adding an enzyme liquid and an enzyme substrate liquid for color change, absorbance or the like is measured to detect an amount of the specific protein. In this method, an operator manually dispenses a primary antibody liquid, a measurement liquid, a cleaning liquid, a secondary antibody liquid, an enzyme liquid, and an enzyme substrate liquid to a plate including multiple wells. Thus, such an operation demands a lot of time and effort. Therefore, if this ELISA method can be performed by using the method of manipulating the droplet, it is possible to reduce time and effort. In this case, it is desirable to perform a simple method at low cost.

For the biochemical analysis on the blood, a microchemical chip has been used since various kinds of tests can be performed in a short time with a small amount of the blood. Herein, plasma of the blood is used according to kinds of the tests and a separating operation of the plasma from the blood is needed. However, the separating operation cannot be performed on the microchemical chip and is performed by using a centrifuge. Meanwhile, the operation using the centrifuge requires a certain amount of the blood, and, thus, it is not appropriate to a demand for using the microchemical chip.

Further, there has been a study of a method for separating the plasma and a blood cell from the blood by using dielectrophoresis. According to this method, an electrode is provided on a plate and an alternating voltage is applied to make a dielectrophoretic reaction, so that the plasma can be separated from the blood. Therefore, if this method is applied to the microchemical chip, the plasma can be separated on the chip. However, even if the above-described method of electrically moving the droplet is used to move the droplet thereafter, the method uses an electric field to move the droplet. Therefore, this method cannot be used with the microchemical chip.

In Patent Document 2, there is described a method of separating serum by inserting a filtering unit to pass the serum (plasma) and block a blood clot into the blood collecting tube and by moving the filtering unit to a boundary between the serum and the blood clot through magnetic force. However, even in this method, the plasma cannot be separated from the blood on a microchemical chip. Therefore, this method cannot solve a problem to be solved by present illustrative embodiments.
Patent Document 1: Japanese Patent Laid-open Publication No. H10-137666
Patent Document 2: Japanese Patent Laid-open Publication No. H05-052841

### BRIEF SUMMARY OF THE INVENTION

In view of the foregoing, present illustrative embodiments provide a technique of moving a droplet along a surface of a moving surface forming member in a simple method. Further, the present illustrative embodiments provide another technique of separating plasma from blood on the surface of the moving surface forming member.

In accordance with one aspect of an illustrative embodiment, there is provided a droplet moving device. The droplet moving device includes a moving surface forming member configured to form a moving surface on which a droplet is moved and made of a nonmagnetic material; a droplet supply unit configured to supply the droplet to a surface of the moving surface forming member; a magnetic field forming member configured to form a magnetic field gradient such that intensity of a magnetic field decreases as a distance from an area where the droplet is positioned on the surface of the moving surface forming member increases along the surface; and a moving unit configured to relatively move the moving surface forming member with respect to the magnetic field forming member along the surface in order to move the droplet along the magnetic field gradient.

In accordance with another aspect of the illustrative embodiment, there is provided a plasma separation device. The plasma separation device includes a moving surface forming member configured to form a moving surface on which a droplet of blood is moved and made of a nonmagnetic material; an electrode provided on the moving surface forming member and configured to make a dielectrophoretic reaction in order to separate plasma from the blood; a magnetic field forming member configured to form a magnetic field gradient such that intensity of a magnetic field decreases as a distance from an area where the droplet is positioned on a surface of the moving surface forming member increases along the surface; and a moving unit configured to relatively move the moving surface forming member with respect to the magnetic field forming member along the surface in order to pass the droplet through the electrode along the magnetic field gradient and separate the plasma from the blood.

In accordance with still another aspect of the illustrative embodiment, there is provided a droplet moving method. The droplet moving method includes supplying a droplet to a surface of a moving surface forming member configured to form a moving surface on which the droplet is moved and made of a nonmagnetic material; forming a magnetic field gradient by a magnetic field forming member such that intensity of a magnetic field decreases as a distance from an area where the droplet is positioned on the surface of the moving surface forming member increases along the surface; and relatively moving the moving surface forming member with respect to the magnetic field forming member along the surface in order to move the droplet along the magnetic field gradient.

Moreover, there is provided a plasma separation method. The plasma separation method includes supplying a droplet of blood to a surface of a moving surface forming member, having an electrode configured to make a dielectrophoretic reaction in order to separate plasma from the blood, configured to form a moving surface on which the droplet of the blood is moved and made of a nonmagnetic material; forming a magnetic field gradient by a magnetic field forming member such that intensity of a magnetic field decreases as a distance from an area where the droplet is positioned on the surface of the moving surface forming member increases along the surface; and moving the droplet along the surface of the moving surface forming member by relatively moving the moving surface forming member with respect to the magnetic field forming member along the surface in order to pass the droplet through the electrode along the magnetic field gradient and separate the plasma from the blood.

In accordance with the illustrative embodiments, when moving the droplet along the surface of the moving surface forming member, the magnetic field gradient is formed by the magnetic field forming member such that intensity of the magnetic field decreases as a distance from an area where the droplet is positioned on the surface of the moving surface forming member increases along the surface. By relatively moving the moving surface forming member with respect to the magnetic field forming member along the surface, the droplet is moved along the magnetic field gradient. In this way, while moving the magnetic field forming member, the droplet is moved along the surface of the moving surface forming member. Therefore, the droplet can be moved in a simple method.

Further, in accordance with the illustrative embodiments, an electrode configured to make a dielectrophoretic reaction is provided on the moving surface forming member, and blood is moved to pass through the electrode, so that a blood cell of the blood is attracted toward the electrode by means of the dielectrophoretic reaction. Meanwhile, plasma of the blood is moved while the magnetic field forming member is moved, so that the plasma can be separated from the blood on the surface of the moving surface forming member.

### BRIEF DESCRIPTION OF THE DRAWINGS

FIG. 1 is a perspective view schematically illustrating a droplet moving device in accordance with an illustrative embodiment;

FIG. 2 is a perspective view of a moving surface forming member used in the droplet moving device;

FIG. 3 is a side view illustrating the droplet moving device;

FIG. 4 is a perspective view illustrating a magnetic field forming member used in the droplet moving device;

FIG. 5 is a cross sectional view illustrating the magnetic field forming member;

FIG. 6 is a plane view schematically illustrating a magnetic field generated by the magnetic field forming member;

FIG. 7 is a cross sectional view illustrating a status where the droplet is moved by the magnetic field forming member along a flow path formed in the moving surface forming member;

FIG. 8 is a perspective view illustrating the status where the droplet is moved along the flow path formed in the moving surface forming member;

FIG. 9 is a cross sectional view illustrating a status where a sample liquid is attracted from a sample liquid storing portion that stores the sample liquid by the magnetic field forming member and the droplet is supplied to the flow path;

FIG. 10 is a plane view illustrating the status where the sample liquid is attracted from the sample liquid storing portion and the droplet is supplied to the flow path;

FIG. 11 is a plane view for explaining a sample liquid analysis method using an ELISA method performed on the moving surface forming member;

FIG. 12 is a perspective view illustrating another example of the droplet moving device in accordance with a modification example of the illustrative embodiment;

FIG. 13 is a side view illustrating another modification example of the droplet moving device in accordance with the illustrative embodiment;

FIG. 14 is a side view illustrating a plasma separation device in accordance with the illustrative embodiment;

FIG. 15 is a perspective view schematically illustrating main parts of the plasma separation device;

FIG. 16 is a plane view illustrating an example of a test plate used in the plasma separation device;

FIG. 17 is a cross sectional view illustrating the status where the droplet is moved by the magnetic field forming member along the flow path formed in the moving surface forming member;

FIG. 18 is a cross sectional view illustrating the status where the droplet is moved by the magnetic field forming member along the flow path formed in the moving surface forming member;

FIG. 19 is a cross sectional view illustrating the status where the droplet is moved by the magnetic field forming member along the flow path formed in the moving surface forming member;

FIG. 20 is a plane view illustrating the status where the droplet is moved by the magnetic field forming member along the flow path formed in the moving surface forming member;

FIG. 21 is a plane view illustrating the status where the droplet is moved by the magnetic field forming member along the flow path formed in the moving surface forming member;

FIG. 22 is a plane view illustrating the status where the droplet is moved by the magnetic field forming member along the flow path formed in the moving surface forming member;

FIG. 23 is a plane view illustrating the status where the droplet is moved by the magnetic field forming member along the flow path formed in the moving surface forming member;

FIG. 24 is a side view illustrating an experimental apparatus used in an experiment of moving the droplet by the magnetic field forming member; and

FIG. 25 is a characteristic graph showing a relationship between a gap between the magnetic field forming members and a droplet amount during the experiment of moving the droplet by the magnetic field forming member.

### DETAILED DESCRIPTION OF THE INVENTION

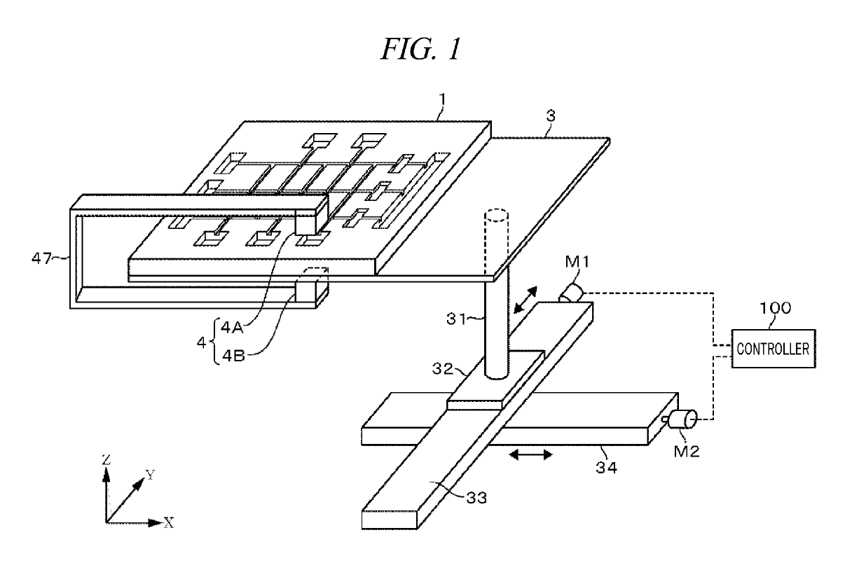

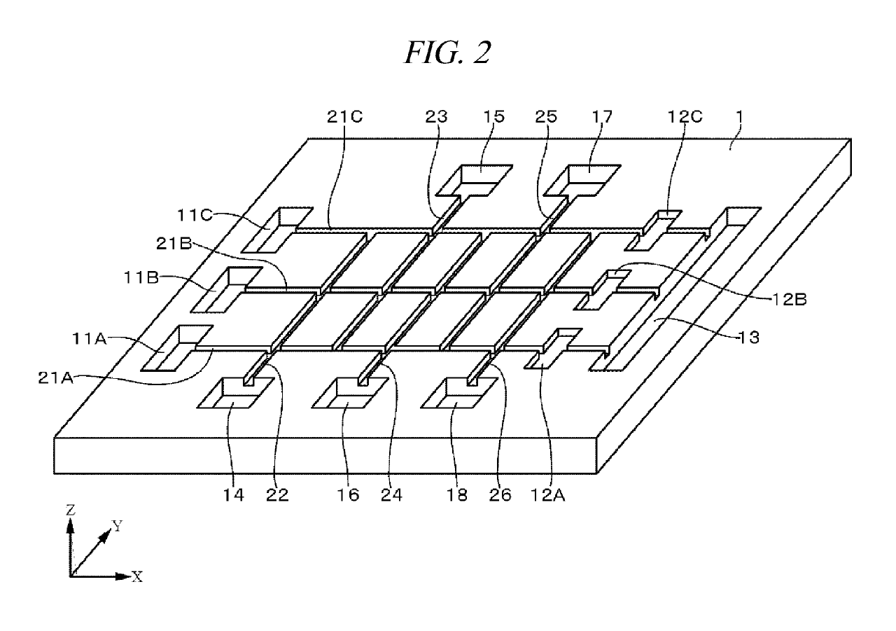

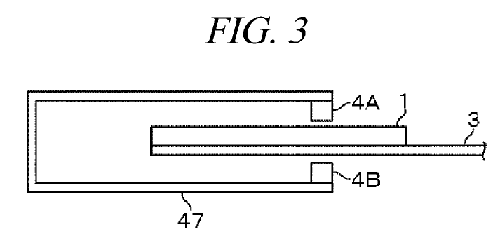

FIG. 1 is a perspective view schematically illustrating a droplet moving device in accordance with an illustrative embodiment. In accordance with the present illustrative embodiment, the droplet moving device includes a moving surface forming member 1 configured to form a moving surface on which a droplet is moved. By way of example, as depicted in FIGS. 1 and 2, the moving surface forming member 1 has a plate shape and is made of a nonmagnetic material such as glass or resin.

The moving surface forming member 1 is configured to use an ELISA method, and an example of the moving surface forming member 1 will be explained with reference to FIG. 2. On a surface of the moving surface forming member 1, there are formed multiple recesses serving as liquid storing portions. These recesses serve as recesses for storing a sample liquid to be analyzed or recesses for storing a chemical liquid for analyzing the sample liquid.

If an end of the moving surface forming member 1 in a longitudinal direction (X-direction in FIG. 2) is an upstream side, multiple, for example, three recesses, as sample liquid storing portions 11A to 11C, for storing the sample liquid to be analyzed are formed to be in parallel with each other at regular intervals on the end. On the other end of the moving surface forming member 1 in the longitudinal direction, there are formed three recesses serving as reaction portions 12A to 12C respectively corresponding to the sample liquid storing portions 11A to 11C. In the reaction portions 12A to 12C, a reaction between a droplet of the sample liquid and a droplet of the chemical liquid is made.

At a downstream side of the reaction portions 12A to 12C, a recess serving as a common liquid drain portion 13 is formed so as to be extended in a widthwise direction (Y-direction in FIG. 2) of the moving surface forming member 1. The sample liquid storing portions 11A to 11C, the reaction portions 12A to 12C, and the liquid drain portion 13 are respectively connected to one another through flow paths 21A to 21C formed in the longitudinal direction of the moving surface forming member 1.

As described later, the sample liquid stored in the sample liquid storing portions 11A to 11C is supplied as a droplet into the flow paths 21A to 21C and moved through these flow paths 21A to 21C toward the reaction portions 12A to 12C, respectively, and also moved to the common liquid drain portion 13 via the reaction portions 12A to 12C.

In the widthwise direction of the moving surface forming member 1, there are formed multiple recesses 14 to for storing the chemical liquid. A cleaning liquid storing portion 14 for storing a cleaning liquid, an antibody liquid storing portion 15 for storing an antibody liquid, an enzyme liquid storing portion 16 for storing an enzyme liquid, a color changing agent storing portion 17 for storing a color changing liquid, and a reaction stop liquid storing portion 18 for storing a reaction stop liquid are formed in this sequence from the upstream side. These recesses 14 to 18 for storing the chemical liquid are connected to the flow paths 21A to 21C via flow paths 22 to 26, respectively, formed in the widthwise direction of the moving surface forming member 1.

As described later, the chemical liquid and the cleaning liquid stored in the recesses 14 to 18 are supplied as a droplet into the flow paths 22 to 26, respectively, and moved to the flow paths 21A to 21C via the flow paths 22 to 26, and also moved to the reaction portions 12A to 12C and to the liquid drain portion 13.

A depth of each of the flow paths 21A to 21C is smaller than a depth of each of the sample liquid storing portions 11A to 11C. Therefore, when viewed from the sample liquid storing portions 11A to 11C, a bottom of each of the flow paths 21A to 21C is positioned higher than a bottom of each of the sample liquid storing portions 11A to 11C. Further, as for the recesses 14 to 18 for storing the chemical liquid and the flow paths 22 to 26, a bottom of each of the flow paths 22 to 26 is positioned higher than a bottom of each of the recesses 14 to 18.

Hereinafter, there will be explained an example of a size of the moving surface forming member 1. If a diameter of the droplet is in a range of, for example, from about 5 mm to about 10 mm, a length, a width and a depth of each of the sample liquid storing portions 11A to 11C is set to be, for example, about 15 mm, about 15 mm and about 0.5 mm, respectively. A size of each of the reaction portions 12A to 12C or the recesses 14 to 18 for storing the cleaning liquid or the chemical liquid is set in the same manner. Further, a width and a depth of each of the flow paths 21A to 21C and 22 to 26 is set to be, for example, from about 5 mm to about 10 mm and about 0.2 mm, respectively.

The moving surface forming member 1 is held on a holder 3. By way of example, the holder 3 has a plate shape and is made of a nonmagnetic material such as glass or resin. Further, the holder 3 is provided at a moving member 32 via a supporting member 31. The moving member 32 can be moved in a Y-axis direction (widthwise direction of the moving surface forming member 1) by a Y-axis driving unit 33, and the Y-axis driving unit 33 can be moved in an X-axis direction (longitudinal direction of the moving surface forming member 1) by an X-axis driving unit 34. By way of example, as the Y-axis driving unit 33 and the X-axis driving unit 34, driving units using ball screws may be used. In the driving units, the ball screws are rotated by motors M1 and M2 constituting driving sections, respectively.

The motors M1 and M2 are connected to a non-illustrated encoder. A controller 100 to be described later controls a movement and a stop of the moving surface forming member 1 via the motors M1 and M2 based on a counting number of pulses of the encoder. In this way, the moving surface forming member 1 can be moved in the longitudinal direction (X-direction) and the widthwise direction (Y-direction). In this example, a moving unit is formed of the holder 3, the supporting member 31, the moving member 32, the X-axis driving unit 34, and the Y-axis driving unit 33.

The droplet moving device includes a magnetic field forming member 4 configured to form a magnetic field gradient such that In this example, the magnetic field forming member 4 is formed of a pair of magnetic field forming members 4A and 4B provided at both sides of the moving surface forming member 1 held on the holder 3 to face each other with the moving surface forming member 1 therebetween.

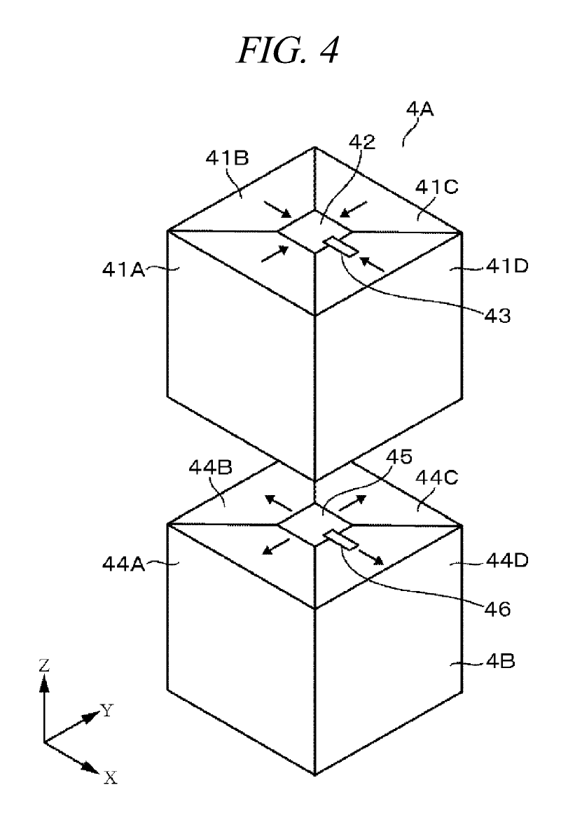

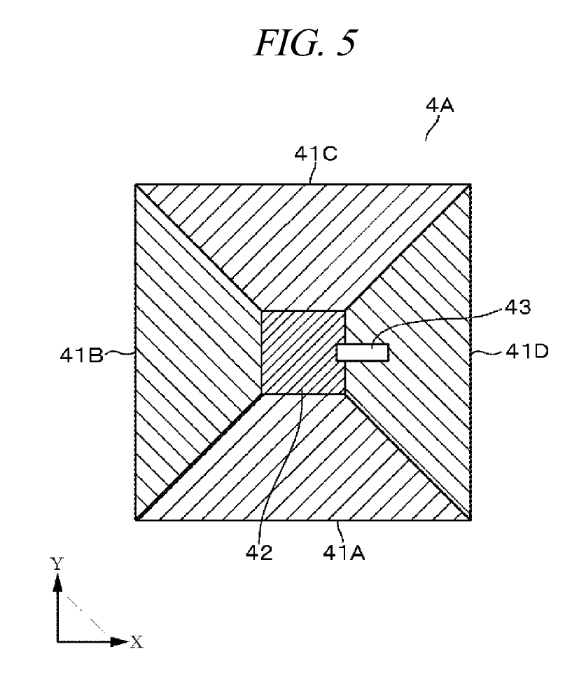

By way of example, as the magnetic field forming members 4A and 4B, magnets including permanent magnets arranged in a Halbach array may be used. To be specific, as for a configuration of the magnetic field forming members 4A and 4B, the magnetic field forming member 4A as an example will be explained with reference to FIG. 4. The magnetic field forming member 4A includes multiple permanent magnets arranged annularly and a core 42 arranged in a central portion thereof and made of a material having high saturation magnetic flux density. In this example, each of the magnetic field forming member 4A and the core 42 has a square pillar shape having a square shape in a plane view and a bottom surface thereof is positioned to be in parallel with the surface of the moving surface forming member 1.

By way of example, as the material having high saturation magnetic flux density, a metal such as iron may be used, and as a material of the permanent magnets 41A to 41D, neodymium may be used. Further, the four permanent magnets 41A to 41D each having a trapezoid shape in a plane view are arranged around the core 42 such that an outward side of the magnetic field forming members 4A becomes N pole. In FIG. 4, arrows indicate directions of magnetic force lines.

The magnetic field forming member 4A is configured to form an area where a magnetic field is locally small. Therefore, as viewed along the surface of the moving surface forming member 1, the magnetic field forming member 4A includes an area where a magnetic permeability is locally small, and this area is formed as a cavity 43 throughout a thickness direction (Z-direction) of the magnetic field forming member 4A. The cavity 43 has a rectangular shape in a plane view. Further, the cavity 43 extends outwards from a vicinity of the central portion of the magnetic field forming member 4A in the longitudinal direction of the moving surface forming member 1 such that the cavity 43 are arranged over the core 42 of the magnetic field forming member 4A and the permanent magnet 41D.

In the same manner as the magnetic field forming member 4A, the magnetic field forming member 4B includes a core 45 arranged in a central portion thereof and made of a material having high saturation magnetic flux density; and four permanent magnets 44A to 44D arranged at an outside of the core 45. Further, a top surface of the magnetic field forming member 4B is positioned to be in parallel with the moving surface forming member 1. The four permanent magnets 44A to 44D of the magnetic field forming member 4B are arranged such that an outward side of the magnetic field forming members 4B becomes S pole. At a position corresponding to the cavity 43 of the magnetic field forming member 4A, a cavity 46 having the same shape as the cavity 43 is formed throughout the thickness direction (Z-direction) of the magnetic field forming member 4B.

As described above, in the respective magnetic field forming members 4A and 4B, the cores 42 and 45 each having high saturation magnetic flux density are provided. Further, the permanent magnets are arranged at the outside of each of the cores 42 and 45 in the same direction as an external magnetic field. Therefore, the magnetic field gradient is formed such that intensity of magnetic fields on lower sides of the cores 42 and 45 is high, and intensity of magnetic fields becomes decreased from the cores 42 and 45 toward the outside. On the lower sides of the cores 42 and 45, areas surrounding the cavities 43 and 46 have locally small magnetic fields.

The magnetic field forming members 4A and 4B is formed such that magnetic poles of the permanent magnets 41 and 44 are different from each other and the permanent magnets 41 and 44 are arranged vertically. Thus, a magnetic field generated in a space between the cores 42 and 45 of the magnetic field forming members 4A and 4B is greater as compared with a case where only one of the magnetic field forming members 4A and 4B is provided. Since the areas surrounding the cavities 43 and 46 have locally small magnetic fields, great magnetic field gradient is formed between the areas surrounding the cavities 43 and 46 and areas outside the cavities 43 and 46. These magnetic field forming members 4A and 4B are fixed to a common supporting frame 47 to face each other at a certain interval.

Hereinafter, there will be explained an example of a size of the magnetic field forming members 4A and 4B. By way of example, a side of each square shape of the magnetic field forming members 4A and 4B is set to be about 50 mm and a side of each square shape of the cores 42 and 45 is set to be about 10 mm. By way of example, a length and a width of each of the cavities 43 and 46 is set to be about 5 mm and about 5 mm, respectively. A thickness of a stacked body including the moving surface forming member 1 and the holder 3 is set to be, for example, about 2 mm. A distance between the bottom surface of the magnetic field forming member 4A and the top surface of the moving surface forming member 1 is set to be, for example, about 1 mm. A distance between a rear surface of the holder 3 and the top surface of the magnetic field forming member 4B is set to be, for example, about 0.5 mm.

The droplet moving device includes the controller 100. The controller 100 is formed of, for example, a computer and includes a data processing unit having a program, a memory, and a CPU. The program includes commands (respective steps) for automatically performing a series of operations of transmitting control signals to the motors M1 and M2 of the droplet moving device from the controller 100 and of moving the droplet along a predetermined moving trajectory. This program is stored in a computer-readable storage medium such as a storage unit including a flexible disk, a compact disk, a hard disk, and a MO (magneto-optical) disk to be installed in the controller 100.

Hereinafter, an operation of the droplet moving device will be explained. In this droplet moving device, a droplet is moved on the surface of the moving surface forming member 1 by means of capillary effect along the magnetic field gradient formed by the magnetic field forming member 4. That is, the surface of the moving surface forming member 1 is located between the two magnetic field forming members 4A and 4B, and, thus, a strong magnetic field is generated therebetween as described above. Meanwhile, the droplet used in the present illustrative embodiment is a weak diamagnetic substance, and, thus, the droplet tends to be away from the strong magnetic field generated between the magnetic field forming members 4A and 4B and moves to an area having a weak magnetic field. If the moving surface forming member 1 is moved with respect to the magnetic field forming members 4, the droplet is moved within the flow paths (21A to 21C and 22 to 26) formed in the moving surface forming member 1 toward an area having the small magnetic field gradient formed by the magnetic field forming members 4. In this case, as the magnetic field gradient is increased, a force from an area having a strong magnetic field toward an area having a weak magnetic field becomes increased, and, thus, the droplet can be moved easily.

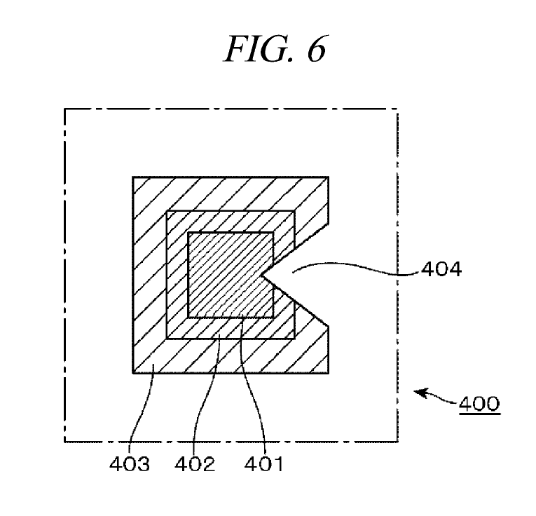

Herein, FIG. 6 illustrates an image of a magnetic field. A magnetic field 400 generated by the magnetic field forming members 4A and 4B is strongest at an area 401 corresponding to the cores 42 and 45 and becomes decreased from the area 401 toward the outside. In FIG. 6, intensity of a magnetic field is expressed in four levels and it is higher in order of a magnetic field 401, a magnetic field 402, a magnetic field 403, and a magnetic field 404. Actually, it decreases continuously.

As described above, in the magnetic field forming members 4A and 4B, the cavities 43 and 46 are extended in the longitudinal direction of the moving surface forming member 1. Therefore, as depicted in FIG. 6, at an area corresponding to the cavities 43 and 46, there is formed a local area 404 having a small magnetic field 404. It is presumed that the local area 404 has a vertex corresponding to the central portion of the cores 42 and 45, and has an isosceles triangle shape extended from the vertex in the longitudinal direction of the moving surface forming member 1. For this reason, the droplet tends to be away from a strong magnetic field. Accordingly, the droplet is accommodated between the two equal sides and trapped in the local area.

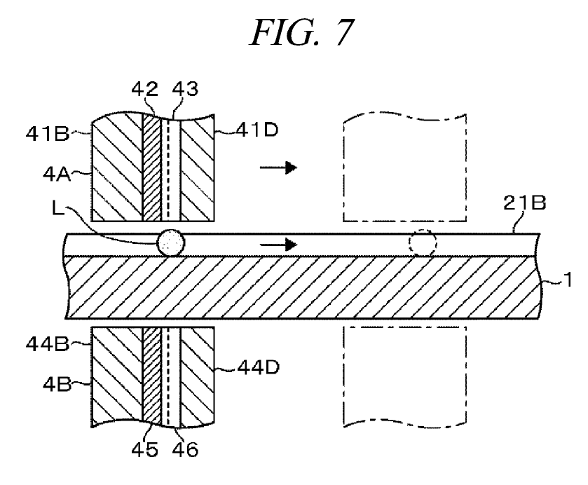

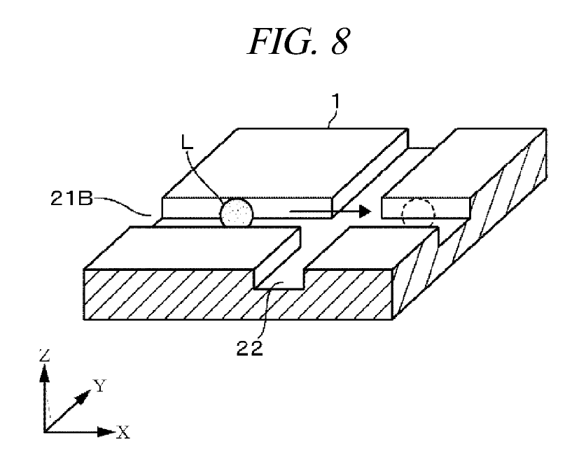

Further, as depicted in FIGS. 7 and 8, the moving surface forming member 1 is moved such that the local area formed by the magnetic field forming members 4A and 4B is positioned in front of a moving direction of the droplet. Thus, the droplet L is moved within the flow paths (21A to 21C and 22 to 26) while being trapped in the local area.

Therefore, when the droplet is moved toward a downstream side along the flow paths 21A to 21C extended in the longitudinal direction (X-direction) of the moving surface forming member 1, if the moving surface forming member 1 is moved toward the upstream side to relatively move the magnetic field forming member 4 toward the downstream side, the droplet is moved within the flow paths 21A to 21C toward the downstream side having the small magnetic field together with the magnetic field forming members 4A and 4B.

Further, when the droplet is moved along the flow paths 22 to 26 extended in the widthwise direction (Y-direction) of the moving surface forming member 1, if the moving surface forming member 1 is moved in a opposite direction to the moving direction of the droplet and the magnetic field forming member 4 is relatively moved in the moving direction of the droplet, the droplet is moved within the flow paths 22 to 26 toward the moving direction's front side having the small magnetic field together with the magnetic field forming members 4A and 4B.

As can be seen from an experimental example to be described later, it is found that since the magnetic field forming members 4A and 4B are formed such that the permanent magnets are arranged in a Halbach array and the permanent magnets are arranged vertically as described above, a magnetic field of about 3.2 Tesla can be formed and the droplet having a diameter of from about 5 mm to about 10 mm can be moved between the magnetic field forming members 4A and 4B.

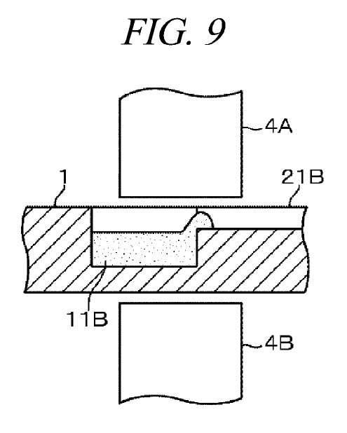

Hereinafter, there will be explained a method of analyzing an amount of an allergen as a specific protein contained in the sample liquid in the droplet moving device by using the ELISA method with reference to FIGS. 9 to 11. Herein, there will be explained an example where a sample liquid stored in the sample liquid storing portion 11B is measured.

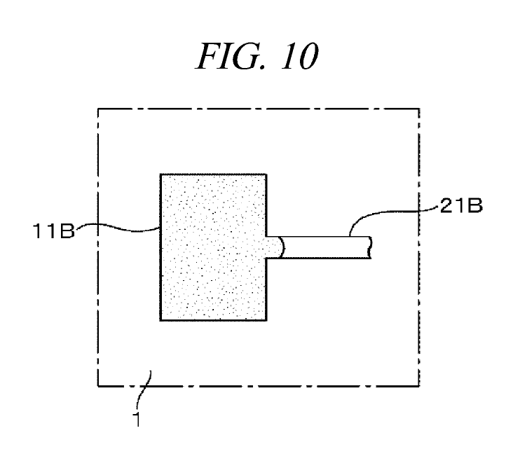

A primary antibody liquid to be bonded to an allergen to be analyzed is supplied in advance to the reaction portion 12B to solidify the primary antibody on a surface of the reaction portion 12. Then, the moving surface forming member 1 is moved such that the local area formed by the magnetic field forming member 4 is moved to a position facing an upstream side of the flow path 21B and the local area is moved from the sample liquid storing portion 11B toward the flow path 21B. Thus, as depicted in FIGS. 9 and 10, the sample liquid stored in the sample liquid storing portion 11B is attracted by a magnetic field generated by the magnetic field forming member 4 and supplied as a droplet into the flow path 21B formed on the surface of the moving surface forming member 1. The droplet has a diameter of from about 5 mm to about 10 mm. As described above, in the present illustrative embodiment, a droplet supply unit is formed of the recesses serving as the sample liquid storing portions 11A to 11C and the magnetic field forming member 4.

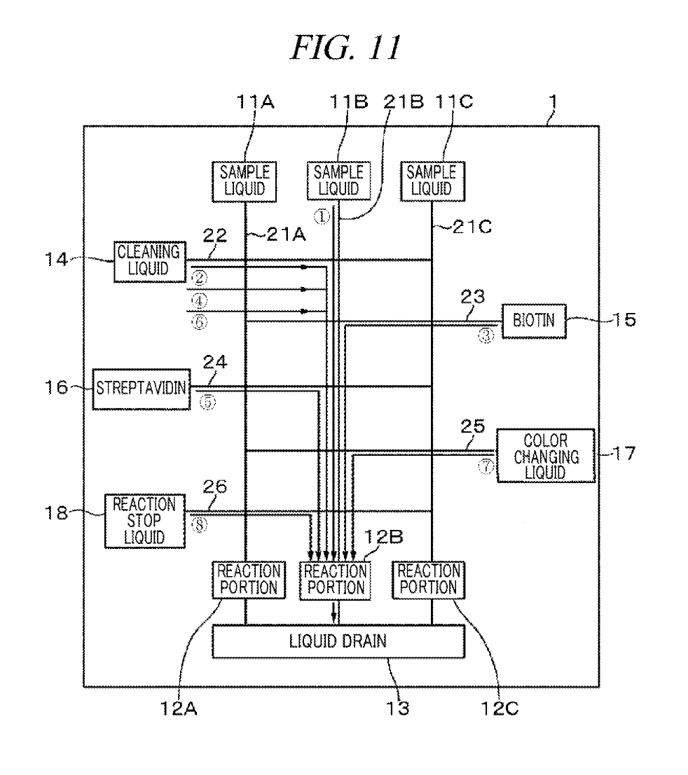

Thereafter, as depicted in FIG. 11, by moving the moving surface forming member 1, the magnetic field forming members 4A and 4B are relatively moved toward the downstream side of the flow path 21B and the droplet L supplied into the flow path 21B is moved to the reaction portion 12B (step 1). Subsequently, the droplet of the sample liquid reacts with the primary antibody in the reaction portion 12B (primary reaction). In this primary reaction, only the specific allergen to be analyzed is bonded to the primary antibody to form a complex.

Then, by moving the moving surface forming member 1, the magnetic field forming members 4A and 4B are relatively moved to supply a droplet of the cleaning liquid from the cleaning liquid storing portion 14 into the flow path 22 in the same manner. The droplet of the cleaning liquid is moved to the reaction portion 12B via the flow paths 22 and 21B (step 2). In the reaction portion 12B, unnecessary components are removed by the cleaning liquid, and phosphate buffered saline may be used as the cleaning liquid. This cleaning process is performed by using the cleaning liquid and includes the processes of moving the cleaning liquid to the reaction portion 12B; and passing the cleaning liquid through the reaction portion 12B to drain the cleaning liquid through the liquid drain portion 13.

Thereafter, a secondary antibody liquid such as a biotin binding antibody liquid is supplied from the antibody liquid storing portion 15 into the flow path 23, and a droplet of the secondary antibody liquid is moved to the reaction portion 12B via the flow paths 23 and 21B in the same manner (step 3). In the reaction portion 12B, there is made a secondary reaction where the complex formed by the primary reaction is bonded to an antibody having the biotin. Subsequently, the droplet of the cleaning liquid is moved from the cleaning liquid storing portion 14 to the reaction portion 12B via the flow paths 22 and 21B, and unnecessary components are removed by the cleaning liquid (step 4).

Then, an enzyme liquid such as an enzyme-streptavidin binding liquid is supplied from the enzyme liquid storing portion 16 into the flow path 24, and a droplet of the enzyme liquid is moved to the reaction portion 12B via the flow paths 24 and 21B in the same manner (step 5). In the reaction portion 12B, there is made an enzyme-substrate reaction where biotin is bonded to streptavidin. Subsequently, the droplet of the cleaning liquid is moved from the cleaning liquid storing portion 14 to the reaction portion 12B via the flow paths 22 and 21B, and unnecessary components are removed by the cleaning liquid (step 6).

Thereafter, a color changing liquid such as o-phenylenediamine liquid is supplied from the color changing agent storing portion 17 into the flow path 25, and a droplet of the color changing liquid is moved to the reaction portion 12B via the flow paths 25 and 21B (step 7). In the reaction portion 12B, the enzyme bonded to the streptavidin reacts with the o-phenylenediamine liquid to be colored.

Then, a reaction stop liquid such as dilute sulphuric acid (0.1 N) is supplied from the reaction stop liquid storing portion 18 into the flow path 26, and a droplet of the reaction stop liquid is moved to the reaction portion 12B via the flow paths 26 and 21B (step 8). Thereafter, absorbance is measured by an absorbance measurement device. By way of example, this measurement is carried out by irradiating light from an upper side of the reaction portion 12B and measuring absorbance at a rear surface of the reaction portion 12B. Therefore, the moving surface forming member 1 is made of material capable of transmitting light. As the amount of the allergen is increased, the absorbance is increased. Thus, an antigen amount of the allergen can be measured by making a comparison with pre-measured absorbance of a reference material. The measured antigen amount is displayed on, for example, an input/output screen (not illustrated) of the controller 100. In this case, the droplets of the sample liquid or the cleaning liquid and other chemical liquids are moved to the reaction portion 12B in a preset order and kept in the reaction portion 12B for a required time, and then, is moved to the liquid drain portion 13.

In accordance with the above-described illustrative embodiment, the magnetic field gradient is formed by the magnetic field forming member 4 such that intensity of the magnetic field decreases as a distance from an area where the droplet is positioned on the surface of the moving surface forming member 1 increases along the surface thereof. Further, the moving surface forming member 1 is moved relatively with respect to the magnetic field forming member 4 along the surface thereof. Therefore, while the magnetic field forming member 4 is relatively moved, the droplet can be moved on the surface of the moving surface forming member 1 through the magnetic field gradient.

In this case, the magnetic field forming member 4 uses the permanent magnets, and, thus, it is not necessary to supply power in order to form a magnetic field. Therefore, it is possible to form a stable magnetic field with a simple configuration as compared with a case of using a complicated circuit pattern in which the droplet is moved by using an electric field or a case of using an electromagnet. Accordingly, manufacturing cost is decreased as compared with the case where the droplet is moved by using an electric field or the case of using an electromagnet. Further, it is not necessary to supply power in order to form a magnetic field, and the motors M1 and M2 of the moving surface forming member 1 serve as driving units. Accordingly, it is possible to maintain easily and to decrease running cost.

In accordance with the above-described droplet moving method, a very small droplet of, for example, about 10 μl can be moved. Thus, it can be applied to a method, such as the ELISA method, of analyzing a specific component of a sample liquid. Although conventionally, an operator manually dispenses a sample liquid or a chemical liquid, and a cleaning liquid to wells on a plate surface, such an operation is not needed. Accordingly, it becomes easy to analyze the component of the sample liquid.

Meanwhile, the magnetic field forming member 4 may not include cavities 43 and 46. Even in this case, the magnetic field gradient is formed by the magnetic field forming member 4 such that intensity of the magnetic field decreases as a distance from an area where the droplet is positioned on the surface of the moving surface forming member 1 increases along the surface. Thus, the moving surface forming member 1 is moved relatively with respect to the magnetic field forming member 4 along the surface thereof, so that the droplet can be moved through the magnetic field gradient.

The magnetic field forming members 4A and 4B are provided at both sides of the moving surface forming member 1, so that a strong magnetic field is generated between the magnetic field forming members 4A and 4B. However, there may be changes in droplet scanning property due to affinity between the droplet and the moving surface forming member 1. Therefore, the magnetic field forming member 4 may be provided at only one side of the moving surface forming member 1.

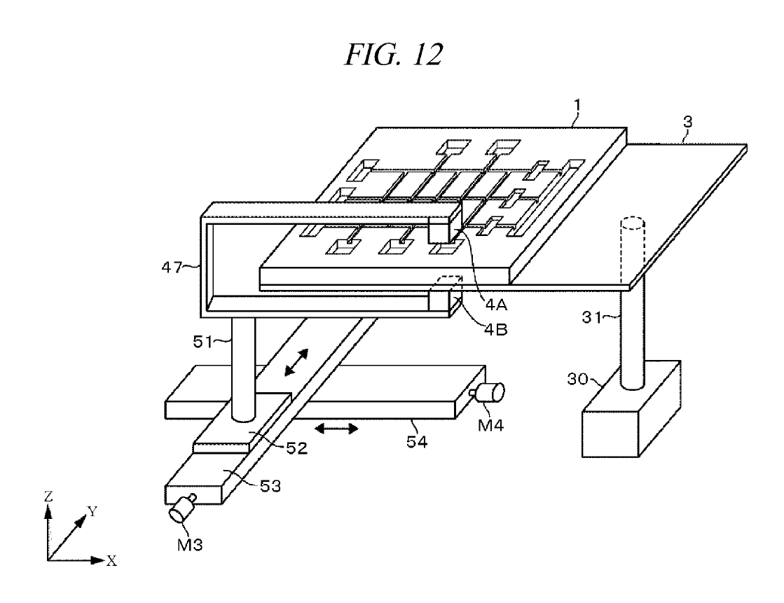

Further, it is enough if the moving surface forming member 1 is relatively moved with respect to the magnetic field forming member 4. As depicted in FIG. 12, the magnetic field forming member 4 may be moved. A reference numeral 30 in FIG. 12 denotes a supporting table of the holder 3 of the moving surface forming member 1. The supporting frame 47 of the magnetic field forming member 4 is configured to be movable in the longitudinal direction (X-direction) and in the widthwise direction (Y-direction) of the moving surface forming member 1 by an X-axis driving unit 54 and a Y-axis driving unit 53 through a supporting member 51 and a moving member 52. By way of example, as the X-axis driving unit 54 and the Y-axis driving unit 53, driving units using ball screws may be used. In FIG. 12, M3 and M4 denote motors of ball screws, respectively.

A configuration of the droplet supply unit is not limited to the above description. By way of example, a syringe-shaped droplet supply unit may be provided above the moving surface forming member 1 to supply the droplet to the surface of the moving surface forming member 1.

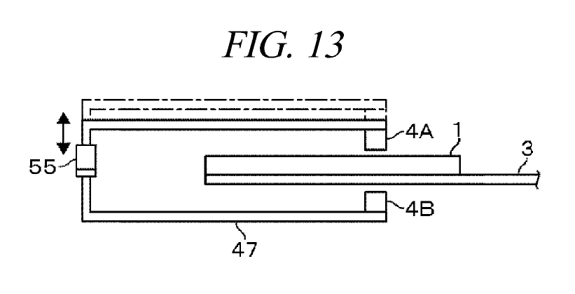

Further, in accordance with the illustrative embodiment, as depicted in FIG. 13, a gap between the magnetic field forming members 4A and 4B provided at both sides of the moving surface forming member 1 may be varied. In the present illustrative embodiment, the magnetic field forming member 4A may be moved up and down with respect to the moving surface forming member 1 by an elevation unit 55. Further, by way of example, by moving the magnetic field forming members 4A and 4B relatively with respect to the moving surface forming member 1, the droplet of the chemical liquid is moved to the reaction portion. Then, by moving the magnetic field forming member 4A upwards, the gap between the magnetic field forming members 4A and 4B is increased. Thereafter, the magnetic field forming members 4A and 4B are relatively moved to a position corresponding to the recess for storing other chemical liquid. With this configuration, when the magnetic field forming members 4A and 4B are relatively moved from the reaction portion to a recess for storing the following chemical liquid, the gap between the magnetic field forming members 4A and 4B is increased and a magnetic field generated therebetween is weakened. Therefore, even if a depth of the reaction portion is shallow or a liquid in the reaction portion has a great amount, the droplet cannot be moved from the reaction portion.

In accordance with the illustrative embodiment, a flow path of the droplet may not be formed on the surface of the moving surface forming member 1. This is because the droplet can be moved to an area having small magnetic field by moving the surface of the moving surface forming member 1 relatively with respect to the magnetic field forming member 4. In particular, as described above, if the magnetic field forming member 4 is formed such that an area having a locally small magnetic field is formed in order to improve efficiency of an operation of trapping the droplet in a local area, the droplet is moved while being trapped in the local area. Therefore, even if a flow path is not formed in the moving surface forming member 1, the droplet can be moved stably.

The droplet moving method can be applied to a PCR method or an immunochromatography method as well as the ELISA method.

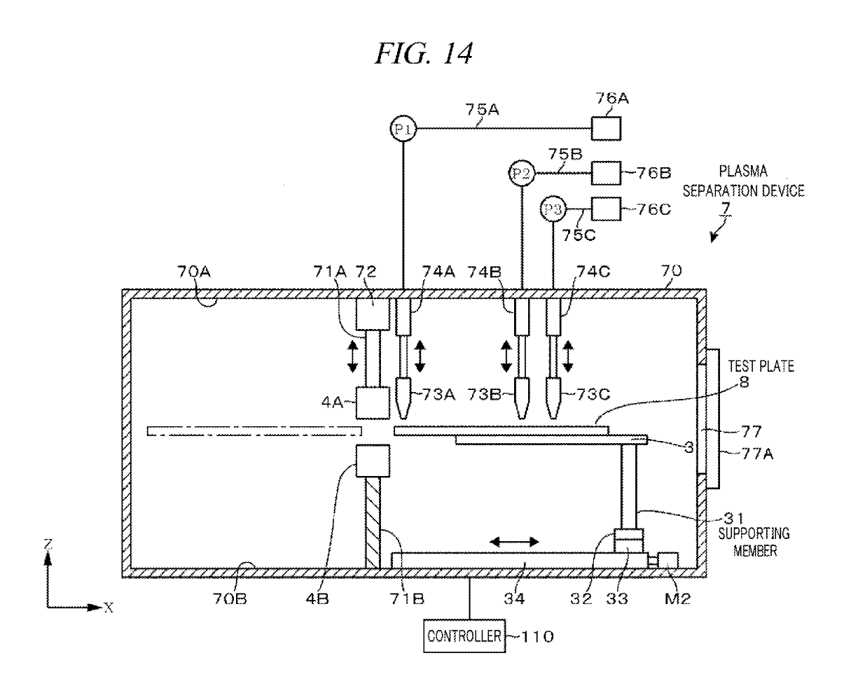

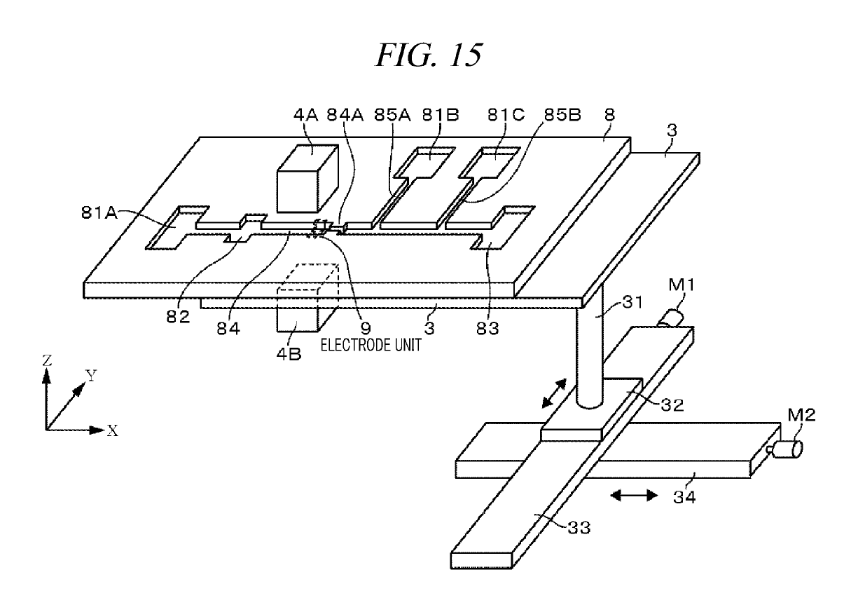

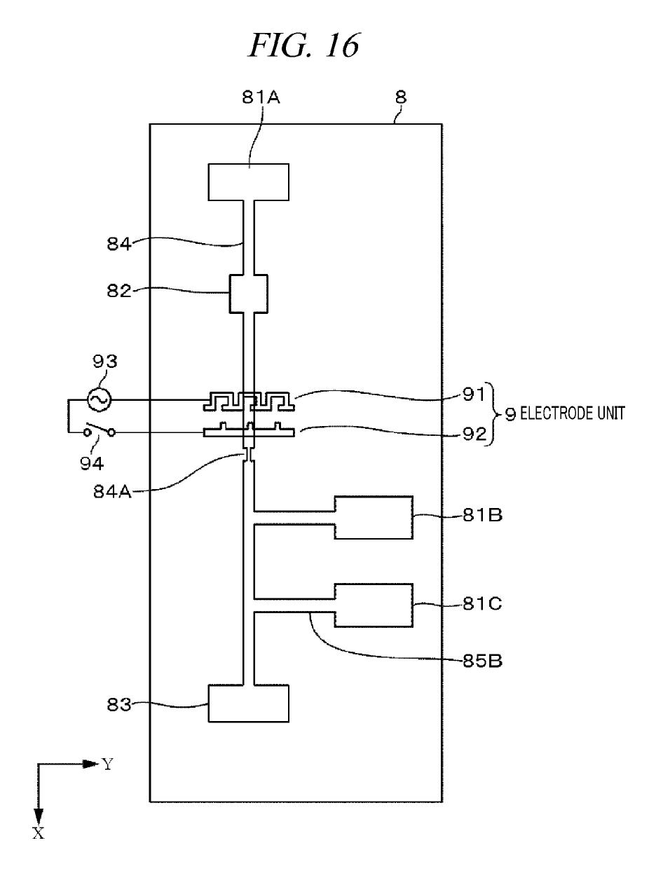

Hereinafter, a plasma separation device will be explained with reference to FIGS. 14 to 23. FIG. 14 is a side view illustrating the plasma separation device in accordance with the illustrative embodiment, FIG. 15 is a schematic perspective view of main parts of the plasma separation device, and FIG. 16 is a plane view of the main parts thereof. A plasma separation device 7 includes a test plate 8 serving as the moving surface forming member; a holder 3 configured to mount the test plate 8; a moving device configured to move the holder 3; and magnetic field forming members 4A and 4B in a processing chamber 70. Hereinafter, in FIG. 14, a longitudinal direction of the processing chamber 70 will be referred to as an X-direction and a widthwise direction of the processing chamber 70 will be referred to as a Y-direction. The same components as described in the above illustrative embodiment are assigned the same reference numerals.

The test plate 8 has a plate shape of, for example, about 3 cm×8 cm, and is made of a nonmagnetic material such as silicon, glass or resin. On a surface of the test plate 8, there are formed multiple recesses serving as liquid storing portions. By way of example, assuming that an end of the test plate 8 in a longitudinal direction (X-direction in FIG. 15) is an upstream side, a recess, as a chemical liquid storing portion 81A, for storing a chemical liquid is formed at the end thereof. At a downstream side thereof, a recess, as a sample liquid storing portion 82, for storing blood to be tested is formed. Further, on the other end of the test plat 8 in the longitudinal direction, a recess serving as a reaction portion 83 is formed. In the reaction portion 83, a reaction between plasma to be described later and a droplet of a chemical liquid for biochemical test is made.

The chemical liquid storing portion 81A, the sample liquid storing portion 82, and the reaction portion 83 are connected to one another through a flow path 84 formed in the longitudinal direction of the test plate 8. Along a widthwise direction of the test plate 8 (Y-direction in FIG. 15), multiple recesses, for example, two recesses in the present illustrative embodiment, for storing chemical liquids for biochemical test of the blood to be described later are formed as chemical liquid storing portions 81B and 81C in sequence from the upstream side. The chemical liquid storing portions 81B and 81C are respectively connected to the flow path 84 through flow paths 85A and 85B formed in the widthwise direction of the test plate 8.

On the surface of the test plate 8, an electrode unit 9 configured to make a dielectrophoretic reaction is provided at the downstream side of the sample liquid storing portion 82 on the flow path 84 and at an upstream side of the flow path 85A. The electrode unit 9 includes a pair of electrodes 91 and 92 provided to intersect with the flow path 84 and to face each other at a certain interval. These electrodes 91 and 92 are connected to each other via a power supply unit 93 for applying an alternating voltage and a switch 94.

Herein, the dielectrophoretic reaction is a phenomenon in which a particle forced by an electric field and an electric dipole moment induced by the electric field is moved within the non-uniform electric field. In the dielectrophoretic reaction, a moving direction of the particle is determined depending on a dielectric characteristic of the particle and the liquid. Therefore, the electrodes 91 and 92 are provided such that the non-uniform electric field is formed. Since a blood cell of the blood is moved to be attracted toward the electrode 91, the electrode 91 is provided at an upstream side of the flow path 84 and is configured to easily trap the blood cell. It is enough if the electrode unit 9 is provided at the downstream side of the sample liquid storing portion 82 and at the upstream side of the flow path 85A. However, when the blood passes through the electrode unit 9, it is divided into the blood cell and the plasma. Accordingly, as described later, it is desirable to provide the electrode unit 9 to be closer to the sample liquid storing portion 82.

By way of example, after the recesses 81A to 81C, 82, and 83 and the flow paths 84, 85A, and 85B are formed at certain positions on the test plate 8, the electrode unit 9 is formed by forming a conductive thin film made of, for example, gold through a deposition process at a certain position on the surface of the test plate 8 and by etching the thin film into a certain electrode pattern. In FIGS. 14 to 19, the electrode unit 9 is enlargely shown for convenience of illustration. Actually, in the electrode unit 9, a pattern width of the electrode is, for example, about 25 μm and a distance between the electrodes 91 and 92 is in a range of, for example, from about 200 μm to about 300 μm. Further, in FIG. 16, the electrodes 91 and 92 are shown much greater than a width of the flow path 84. However, actually, the electrodes 91 and 92 may be formed to be substantially equal to or slightly greater than the flow path 84. Furthermore, the electrode unit 9 may be formed on a rear surface of the test plate 8.

The flow path 84 on the surface of the test plate 8 includes a portion 84A having a locally narrower width at a downstream side of the electrode unit 9. Although, in the present illustrative embodiment, the portion 84A is formed at a vicinity of the downstream side of the electrode unit 9, since the droplet of the plasma is separated while passing through this portion 84A as described later, a position of the portion 84A may be at the downstream side of the sample liquid storing portion 82 and at the upstream side of the flow path 85A. By way of example, the width of the flow path 84 is set to be about 3 mm and a width of the portion 84A is set to be about 2 mm.

By way of example, the holder 3 has a rectangular plate shape extended in the X-direction to support a part of the test plate 8. The holder 3, the supporting member 31, the moving member 32, the X-axis driving unit 34, the Y-axis driving unit 33, and the motors M1 and M2 are configured in the same manner as described in the above illustrative embodiment, and, thus, explanations thereof will be omitted. Herein, a position of the holder 3 illustrated in FIG. 14 is a transfer position of the test plate 8 with respect to the holder 3 as described later. The test plate 8 is mounted on the holder 3 at this position and moved toward an end side of the X-direction (left side in FIG. 14). Therefore, hereinafter, the end side will be referred to as a front side of a moving direction and the other end side of the X-direction (right side in FIG. 14) will be referred to as a rear side of the moving direction.

The magnetic field forming members 4A and 4B are provided at both sides of the test plate 8 mounted on the holder 3 to face each other with the test plate 8 therebetween. In the present illustrative embodiment, the magnetic field forming members 4A and 4B are provided at the front side of the moving direction with respect to the test plate 8 mounted on the holder 3 at the transfer position. Further, the magnetic field forming members 4A and 4B are provided at a substantially central portion of the test plate 8 in the Y-direction in order not to interfere with the test plate 8. The magnetic field forming members 4A and 4B are configured in the same manner as the magnetic field forming members 4A and 4B described in the above illustrative embodiment except that the cavity 43 is extended in the X-direction, and, thus, explanation thereof will be omitted.

The magnetic field forming members 4A and 4B are provided at a ceiling portion 70A and at a bottom portion 70B of the processing chamber 70 via supporting members 71A and 71B, respectively, to face each other at a certain interval. Further, by way of example, the upper supporting member 71A of the magnetic field forming member 4A is configured to be movable up and down by an elevation unit 72 between a droplet moving position where the magnetic field forming members 4A and 4B are the closest to each other and a standby position higher than the droplet moving position. A gap between the magnetic field forming members 4A and 4B may be varied. Further, the gap between the magnetic field forming members 4A and 4B is set such that the test plate 8 mounted on the holder 3 can pass through the gap when the magnetic field forming member 4A is positioned at the droplet moving position.

The above-described plasma separation device 7 includes first to third supply nozzles 73A to 73C for supplying a chemical liquid to a certain position of the test plate 8 on the holder 3 at the transfer position. The first supply nozzle 73A supplies anticoagulant such as a sodium citrate liquid to the chemical liquid storing portion 81A of the test plate 8 at the transfer position, the second supply nozzle 73B and the third supply nozzle 73C supply chemical liquids A and B for biochemical test of the blood to the chemical liquid storing portions 81B and 81C on the test plate 8 at the transfer position, respectively. In the present illustrative embodiment, these supply nozzles 73A to 73C are configured to be movable up and down between a supply position where a chemical liquid is supplied to the test plate 8 on the holder 3 and a transfer position higher than the supply position by elevation units 74A to 74C provided at the ceiling portion 70A of the processing chamber 70. The transfer position is set in order not to interfere with a transfer of the test plate 8 when the test plate 8 is transferred onto the holder 3.

These supply nozzles 73A to 73C are connected to a sodium citrate liquid source 76A, a chemical liquid A source 76B, and a chemical liquid B source 76C through supply paths 75A to 75C including pumps P1 to P3, respectively. By operating the pumps P1 to P3, the sodium citrate liquid of, for example, about 100 μl, the chemical liquid A of, for example, about 100 μl, and the chemical liquid B of, for example, about 100 μl are respectively supplied to chemical liquid storing portions 81A to 81C on the test plate 8 at the transfer position. The sodium citrate liquid and the like may be supplied to the test plate 8 by opening and closing valves instead of operating the pumps P1 to P3. In the present illustrative embodiment, a droplet supply unit is formed of the supply nozzles 73A to 73C, the pumps P1 to P3, the supply paths 75A to 75C, and the chemical liquid sources 76A to 76C. A reference numeral 77 in FIG. 14 denotes an opening through which the test plate 8 is transferred onto the holder 3, and a reference numeral 77A denotes an opening/closing member of the opening 77.

Further, the plasma separation device 7 includes a controller 110. The controller 110 is formed of, for example, a computer and includes a data processing unit having a program, a memory, and a CPU. The program includes commands (respective steps) for automatically performing a series of operations of transmitting control signals to each component of the motors M1 and M2, the pumps P1 to P3, and the elevation units 72 and 74A to 74C of the plasma separation device 7 from the controller 110, supplying a certain chemical liquid to the test plate 8 on which the blood is dropped, moving the blood along a predetermined moving trajectory, and performing a preset test in a reaction portion. This program is stored in a computer-readable storage medium such as a storage unit including a flexible disk, a compact disk, a hard disk, and a MO (magneto-optical) disk to be installed in the controller 110.

Hereinafter, a plasma separation method performed in the plasma separation device 7 will be explained. By way of example, about 100 μl of blood 95 to be tested is dropped by a syringe or the like onto the sample liquid storing portion 82 of the test plate 8. Then, the test plate 8 is loaded into the plasma separation device 7 through the opening 77, and then, mounted on the holder 3 positioned at the transfer position. Thereafter, the opening 77 is closed by the opening/closing member 77A and the pumps P1 and P2 are operated to supply the sodium citrate liquid of about 100 μl of and the chemical liquid A of about 100 μl of to the chemical liquid storing portions 81A and 81B of the test plate 8 from the supply nozzles 73A and 73B, respectively.

Subsequently, the switch 94 is turned on and an alternating voltage of, for example, about 1 MHz and about 10 V is applied to the electrode unit 9. The motors M1 and M2 are operated to move the test plate 8 along a certain pathway. That is, the test plate 8 is moved to a position where the local area of a magnetic field generated by the magnetic field forming member 4 faces the chemical liquid storing portion 81A, and the test plate 8 is moved such that the local area is moved toward the flow path 84 from the chemical liquid storing portion 81A. Thus, the sodium citrate liquid in the chemical liquid storing portion 81A is attracted by the magnetic field formed by the magnetic field forming member 4 and supplied as a droplet into the flow path 84. The droplet has a diameter in a range of from about 5 mm to about 10 mm. In the present illustrative embodiment, the droplet supply unit is formed of the magnetic field forming member 4 and the recesses serving as the chemical liquid storing portions 81A to 81C.

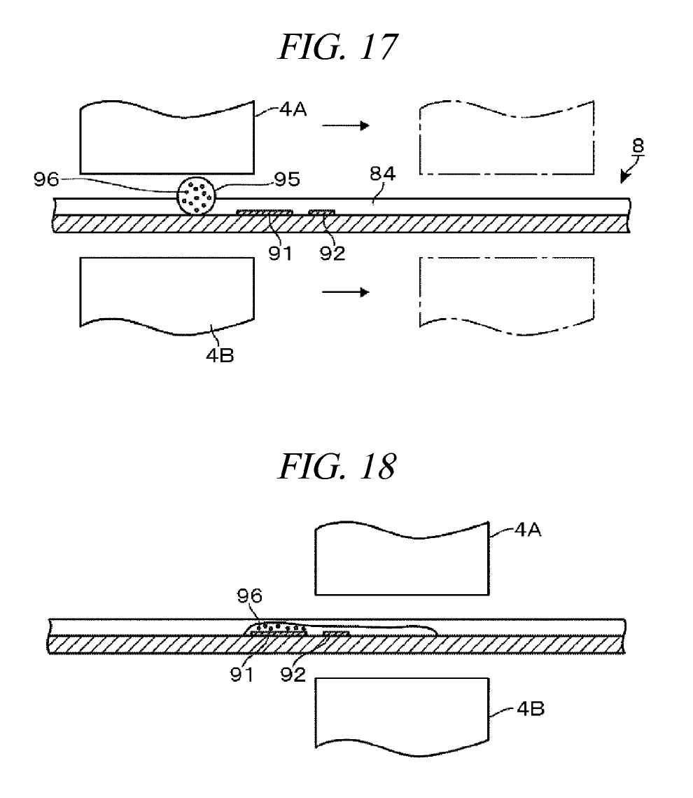

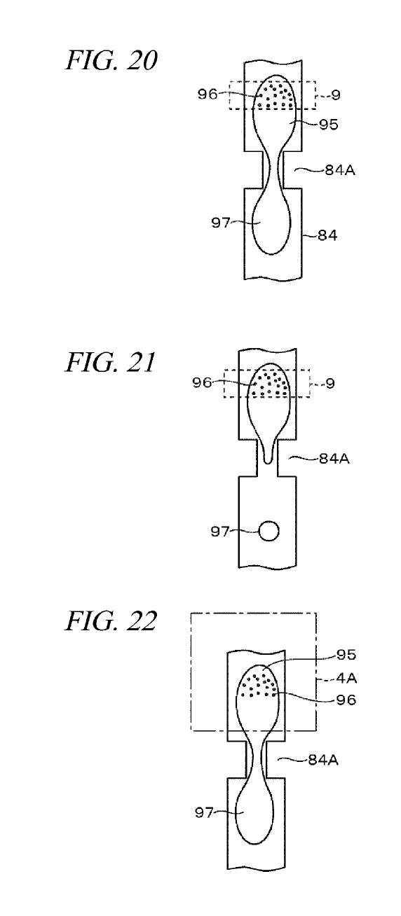

Then, by moving the test plate 8, the magnetic field forming member 4 is relatively moved toward a downstream side of the flow path 84. The droplet of the sodium citrate liquid is moved to the sample liquid storing portion 82 to dilute the blood 95. Thereafter, by moving the magnetic field forming member 4 in the same manner, the droplet of the diluted blood 95 is moved to the downstream side of the flow path 84 as depicted in FIG. 17. Herein, when the droplet of the blood 95 is moved through the electrode unit 9, a dielectrophoretic reaction is made thereon and a blood cell 96 in the blood 95 is moved to be attracted toward the electrode unit 9, specifically, the electrode 91 as depicted in FIGS. 18 and 20. Meanwhile, plasma 97 of the blood 95 is not attracted toward the electrode unit 9, and, thus, it is moved along with the relative movement of the magnetic field forming member 4. In FIGS. 20 and 21, an electrode arrangement area where the electrode unit 9 is provided is indicated by a dotted line.

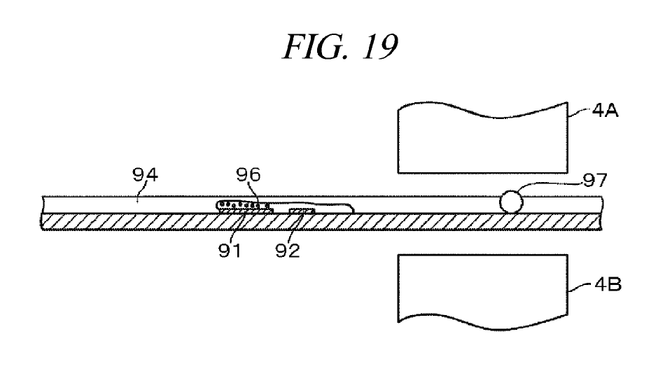

Accordingly, if the magnetic field forming member 4 is relatively moved toward the downstream side from the sample liquid storing portion 82, the blood 95 at a vicinity of the electrode arrangement area is moved toward the downstream side while diffused as depicted in FIGS. 18 and 20. Further, if the magnetic field forming member 4 is relatively moved toward an upstream side of the portion 84A where the width of the flow path 84 becomes narrower, the plasma 97 of the blood 95 passes through the portion 84A, and then, is moved toward the downstream side as it is pressed out by the magnetic field of the magnetic field forming member 4. If the magnetic field forming member 4 is further relatively moved toward a downstream side with respect to the portion 84A, a liquid amount in the portion 84A is extremely reduced. Therefore, while the magnetic field forming member 4 is relatively moved, the plasma 97 is attracted from the blood 95 and a droplet of the plasma 97 is formed (see FIGS. 19 and 21).

In this way, the plasma 97 is separated from the blood 95, and the droplet of the plasma 97 is moved to the reaction portion 83 by relatively moving the magnetic field forming member 4. Then, after increasing the gap between the magnetic field forming members 4A and 4B, the magnetic field forming member 4 is relatively moved toward a vicinity of the chemical liquid storing portion 81B. After decreasing the gap between the magnetic field forming members 4A and 4B, the magnetic field forming member 4 is relatively moved to supply the droplet of the chemical liquid A into the flow path 85A. The droplet of the chemical liquid A is moved to the reaction portion 83 via the flow paths 85A and 84. In this way, the droplet of the chemical liquid A reacts with the plasma in the reaction portion 83 and a preset biochemical test is performed thereon. After completing the biochemical test using the chemical liquid A, the test plat 8 is taken out of the plasma separation device 7 through the opening 77 and destroyed. Although there has been explained a case where a biochemical test is performed by using the chemical liquid A in the above-described illustrative embodiment, a biochemical test may be performed by using the chemical liquid B in the same manner.

In accordance with the above-described illustrative embodiment, a dielectrophoretic reaction occurs on the test plate 8, and, thus, the plasma can be separated from the blood on the test plate 8. Further, the separated plasma is moved on the test plate 8 by using a magnetic field of the magnetic field forming member 4, and, thus, the plasma can be moved without interfering with the dielectrophoretic reaction. For this reason, separation of the plasma from the blood and movement of the plasma can be carried out on the test plate 8, and a biochemical test on the plasma can be performed on the test plate 8. Thus, various biochemical tests can be performed in a short time with a small-sized device using a small amount of the blood.

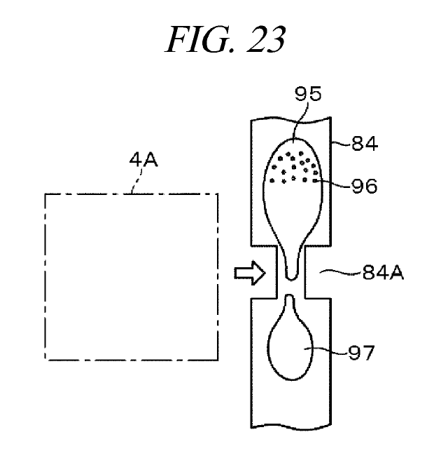

The plasma 97 may be separated from the droplet of the blood 95 in the following manner. That is, as depicted in FIG. 22, the magnetic field forming members 4A and 4B are relatively moved toward the downstream side of the flow path 84 to a vicinity of the portion 84A having a narrower width to diffuse the blood 95 to the downstream side of the portion 84A. Then, after increasing the gap between the magnetic field forming members 4A and 4B, and the magnetic field forming members 4A and 4B are relatively moved toward a side of the portion 84A as depicted in FIG. 23. Further, as indicated by an arrow in FIG. 23, the magnetic field forming members 4A and 4B are moved toward the portion 84A. Thus, since the plasma 97 within the portion 84A tends to be away from a magnetic field, the plasma 97 is moved toward both ends of the portion 84A. Therefore, the plasma 97 can be easily separated from the blood 95.

If a biochemical test is performed by using various chemical liquids on the same test plate 8, recesses serving as multiple chemical liquid storing portions 81 and the reaction portion 83 may be formed. Further, the plasma 97 may be moved to the chemical liquid storing portions 81 instead of the reaction portion 83 to react with chemical liquids therein. Furthermore, a liquid drain portion may be provided at a downstream side of the reaction portion 83. After a reaction liquid reacts with the chemical liquid A in the reaction portion 83, the reaction liquid may be drained through the liquid drain portion. The following droplet of the plasma 97 and the chemical liquid B may be moved to the reaction portion 83 to perform a biochemical test by using the chemical liquid B.

A sodium citrate liquid may be dropped directly onto the sample liquid storing portion 82 to dilute blood or a chemical liquid may be dropped directly onto the reaction portion 83 to react with plasma. In the test plate 8, a flow path may not be formed and a recess serving as the liquid storing portion 82 or the chemical liquid storing portions 81 may not be formed. Further, the magnetic field forming member 4 may be moved instead of the test plate 8.

After the blood 95 is moved on the test plate 8 to pass through the electrode unit 9 and the droplet of the plasma 97 is separated from the blood 95, the droplet of the plasma 97 may be moved by an electrical method. If the plasma 97 can be separated from the blood 95 by relatively moving the magnetic field forming member 4 depending on a width of a flow path, intensity of an electric field of the electrode unit 9, or intensity of a magnetic field of the magnetic field forming member 4, the flow path 84 does not necessarily include the portion 84A having a locally narrower width.

### Experimental Example

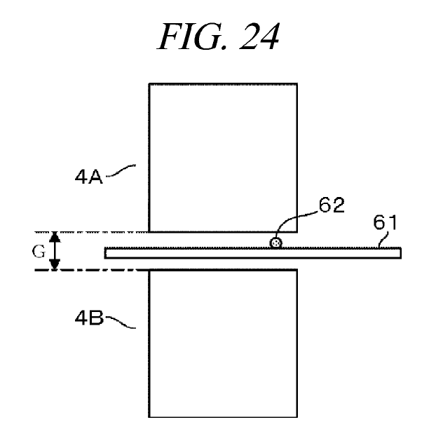

Hereinafter, an experiment for checking whether or not a droplet is moved by moving a magnetic field forming member through an experimental apparatus depicted in FIG. 24. A reference numeral 61 in FIG. 24 denotes a moving surface forming member, made of silicon, having a thickness of about 0.75 mm. Further, reference numerals 4A and 4B denote magnetic field forming members provided at both sides of the moving surface forming member. The magnetic field forming members 4A and 4B used herein have the same configuration as described above. A permanent magnet is made of neodymium, and an intermediate member is made of iron. A magnetic field forming member 4 has the same size as described above. By changing a gap (gap between magnets) G between the magnetic field forming members 4A and 4B and a droplet amount, it was observed whether or not a droplet 62 is moved while the magnetic field forming member 4 is moved. Further, the droplet having a diameter of about 5 mm to about 10 mm corresponds to the droplet having an amount of about 20 μl to about 100 μl.

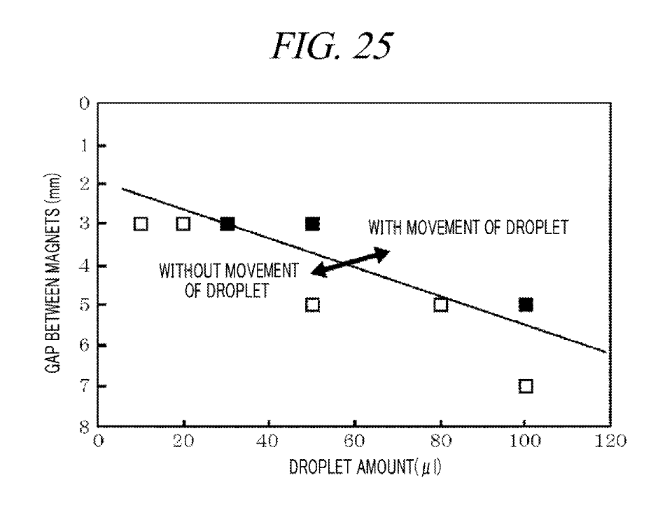

A result thereof is shown in FIG. 25. In FIG. 25, a vertical axis represents the gap between magnets, and a horizontal axis represents the droplet amount. Further, ▪ represents the droplet that is moved by moving the magnetic field forming member, and □ represents the droplet that is not moved. According to this result, it is found that the droplet is moved on a surface of the moving surface forming member by moving the magnetic field forming member. Further, it is understood that when the droplet amount is small, magnetic flux density needs to be increased by reducing the gap between the magnetic field forming members in order to move the droplet.

What is claimed is:

1. A droplet moving device comprising:
a moving surface forming member configured to form a moving surface on which a droplet is moved and made of a nonmagnetic material;
a droplet supply unit configured to supply the droplet to a surface of the moving surface forming member;
a magnetic field forming member configured to form a magnetic field gradient such that intensity of a magnetic field decreases as a distance from an area where the droplet is positioned on the surface of the moving surface forming member increases along the surface; and
a moving unit configured to relatively move the moving surface forming member with respect to the magnetic field forming member along the surface in order to move the droplet along the magnetic field gradient.

2. The droplet moving device of claim 1,
wherein the moving surface forming member has a plate shape, and
the magnetic field forming member is provided at both sides of the moving surface forming member with the moving surface forming member therebetween.

3. The droplet moving device of claim 1, further comprising:
a controller configured to control the moving unit to move the droplet along a predetermined moving trajectory.

4. The droplet moving device of claim 1,
wherein the magnetic field forming member is configured to form a local area having a locally smaller magnetic field than a vicinity thereof along the surface in order to efficiently trap the droplet in the local area.

5. The droplet moving device of claim 4,
wherein the magnetic field forming member includes a portion where a magnetic permeability is locally small when viewed along the surface in order to form the local area.

6. The droplet moving device of claim 5,
wherein the portion where the magnetic permeability is locally small is formed as a cavity.

7. The droplet moving device of claim 1,
wherein a recess serving as a liquid storing portion is formed on the moving surface forming member, a liquid in the recess is attracted by the magnetic field generated by the magnetic field forming member to be supplied as the droplet to the surface of the moving surface forming member, and
the droplet supply unit includes the recess and the magnetic field forming member.

8. The droplet moving device of claim 1,
wherein the droplet supply unit includes a droplet supply unit configured to supply a droplet of a sample liquid to be analyzed, a droplet supply unit configured to supply a droplet of a chemical liquid for analyzing the sample liquid, and a droplet supply unit configured to supply a cleaning liquid, and
the moving surface forming member includes a reaction portion where the droplet of the sample liquid to be analyzed reacts with the chemical liquid.

9. A plasma separation device comprising:
a moving surface forming member configured to form a moving surface on which a droplet of blood is moved and made of a nonmagnetic material;
an electrode provided on the moving surface forming member and configured to make a dielectrophoretic reaction in order to separate plasma from the blood;
a magnetic field forming member configured to form a magnetic field gradient such that intensity of a magnetic field decreases as a distance from an area where the droplet is positioned on a surface of the moving surface forming member increases along the surface; and
a moving unit configured to relatively move the moving surface forming member with respect to the magnetic field forming member along the surface in order to pass the droplet through the electrode along the magnetic field gradient and separate the plasma from the blood.

10. The plasma separation device of claim 9,
wherein a flow path configured to guide the droplet is formed on the surface of the moving surface forming member.

11. The plasma separation device of claim 10,
wherein the flow path has a narrow portion having a narrower width at a downstream side of the electrode provided on the moving surface forming member, and
the moving unit moves the droplet from an upstream side of the electrode to a downstream side of the narrow portion in the flow path, and the plasma is separated from the blood while the droplet passes through the narrow portion.

12. The plasma separation device of claim 9,
wherein the moving surface forming member includes a reaction portion where a droplet of the plasma to be analyzed reacts with a chemical liquid at a downstream side of the electrode, and
the moving unit moves the separated plasma to the reaction portion.

13. A droplet moving method comprising:
supplying a droplet to a surface of a moving surface forming member configured to form a moving surface on which the droplet is moved and made of a nonmagnetic material;
forming a magnetic field gradient by a magnetic field forming member such that intensity of a magnetic field decreases as a distance from an area where the droplet is positioned on the surface of the moving surface forming member increases along the surface; and
relatively moving the moving surface forming member with respect to the magnetic field forming member along the surface in order to move the droplet along the magnetic field gradient.

14. The droplet moving method of claim 13,
wherein the moving surface forming member has a plate shape, and
the magnetic field forming member is provided at both sides of the moving surface forming member with the moving surface forming member therebetween.

15. A plasma separation method comprising:
supplying a droplet of blood to a surface of a moving surface forming member, having an electrode configured to make a dielectrophoretic reaction in order to separate plasma from the blood, configured to form a moving surface on which the droplet of the blood is moved and made of a nonmagnetic material;
forming a magnetic field gradient by a magnetic field forming member such that intensity of a magnetic field decreases as a distance from an area where the droplet is positioned on the surface of the moving surface forming member increases along the surface; and
moving the droplet along the surface of the moving surface forming member by relatively moving the moving surface forming member with respect to the magnetic field forming member along the surface in order to pass the droplet through the electrode along the magnetic field gradient and separate the plasma from the blood.

16. The plasma separation method of claim 15,
wherein in moving the droplet along the surface of the moving surface forming member, the droplet is moved within a flow path formed on the surface of the moving surface forming member.

17. The plasma separation method of claim 16,
wherein the flow path has a narrow portion having a narrower width at a downstream side of the electrode provided on the moving surface forming member, and
in moving the droplet along the surface of the moving surface forming member, the droplet is moved from an upstream side of the electrode to a downstream side of the narrow portion in the flow path, the droplet is passed through the narrow portion, and the plasma is separated from the blood.
